(19) United States
(12) Patent Application Publication
(10) Pub. No.: US 2010/0048813 A1
(43) Pub. Date: Feb. 25, 2010

(54) HIGHLY-BRANCHED OR HYPER-BRANCHED POLYESTER AND THE PRODUCTION AND APPLICATION THEREOF

(75) Inventors: Joachim Clauss, Darmstadt (DE); Marta Martin-Portugues, Ludwigshafen (DE); Harald Schaefer, Mannheim (DE); Daniel Schoenfelder, Mannheim (DE); Bernd Bruchmann, Freinsheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/514,801

(22) PCT Filed: Nov. 8, 2007
(86) PCT No.: PCT/EP2007/062054

§ 371 Date: May 14, 2009

(30) Foreign Application Priority Data
Nov. 14, 2006 (EP) 06124049.5

(51) Int. Cl. C08L 67/02; C08G 63/16

(52) U.S. Cl. 524/604; 528/300

(57) ABSTRACT

The present invention relates to highly branched or hyperbranched polyesters of specific construction, based on mono-, di-, tri- or polycarboxylic acids or derivatives thereof and mono-, di-, tri-, tetra- or polyols, to processes for preparing them, and to their use.

The present invention relates to highly branched or hyperbranched polyesters of specific construction, based on mono-, di-, tri- or polycarboxylic acids or derivatives thereof and mono-, di-, tri-, tetra- or polyols, to processes for preparing them, and to their use.

The highly branched or hyperbranched polyesters of the invention can be used with advantage industrially as, among other things, adhesion promoters, in printing inks for example, as rheology modifiers, as surface or interface modifiers, as functional polymer additives, as building blocks for preparing polyaddition or polycondensation polymers, for example paints, coverings, adhesives, sealants, casting elastomers or foams, and also as a constituent of binders, together if appropriate with other components such as, for example, isocyanates, epoxy-functional binders or alkyd resins, in adhesives, printing inks, coatings, foams, coverings and paints, dispersions, as surface-active amphoterics and in thermoplastic molding compounds.

Polyesters are customarily obtained from the reaction of carboxylic acids or derivatives thereof with alcohols.

Of industrial significance are aromatic polyesters, i.e., polyesters comprising ester groups, the molecular parent units deriving definitively on the one hand from aromatic dicarboxylic acids, such as from phthalic acid, isophthalic acid or terephthalic acid, for example, and on the other hand from dialcohols, such as 1,2-ethanediol, 1,2- or 1,3-propanediol or 1,4-butanediol.

Additionally of industrial significance are aliphatic polyesters, i.e., polymers comprising ester groups, the molecular parent units definitively deriving, on the one hand, from aliphatic or cycloaliphatic dicarboxylic acids, such as from succinic acid, glutaric acid or adipic acid, for example, and on the other hand from dialcohols, such as 1,2-ethanediol, 1,2- or 1,3-propanediol, 1,2-, 1,3- or 1,4-butanediol, 1,5-pentanediol or 1,6-hexanediol.

Additionally of industrial significance are fully aromatic liquid-crystalline polyesters, i.e., polymers comprising ester groups, the molecular parent units definitively deriving from aromatic dicarboxylic acids, aromatic dialcohols, and aromatic hydroxycarboxylic acids.

The aromatic or aliphatic polyesters synthesized from these building blocks are generally of linear construction or else are constructed with a low degree of branching. Polyesters based on carboxylic acids and/or derivatives or alcohols with a functionality of more than two are likewise known.

Thus WO 02/34814 describes a process for preparing polyesters using up to 3 mol % of a trifunctional alcohol or of a trifunctional carboxylic acid. In view of the low proportion of trifunctional alcohol in that case, however, the degree of branching achieved is no more than low.

U.S. Pat. No. 4,749,728 describes a process for preparing a polyester from trimethylolpropane and adipic acid. The process is carried out in the absence of solvents and catalysts. The water formed during the reaction is removed by simple distillation. The products obtained in this way can be reacted, for example, with epoxides and processed to thermosetting coating systems.

EP-A 0 680 981 discloses a process for synthesizing polyester polyols which comprises heating a polyol, glycerol for example, and adipic acid at 150-160° C. in the absence of catalysts and solvents. Products are obtained which are suitable as polyester polyol components for rigid polyurethane foams.

WO 98/17123 discloses a process for preparing polyesters of glycerol and adipic acid which are used in chewing gum masses. They are obtained by a solvent-free process without using catalysts. After 4 hours gels begin to form in this case. Gelatinous polyester polyols, however, are unwanted for numerous applications such as printing inks and adhesives, for example, since they lead to lumps forming and they detract from the dispersing properties.

The abovementioned WO 02/34814 describes the preparation of polyesterols with low degrees of branching for powder coating materials by reaction of aromatic dicarboxylic acids together with aliphatic dicarboxylic acids and diols and also with small amounts of a branching agent, such as a triol or tricarboxylic acid, for example.

EP-A 776 920 describes binders formed from polyacrylates and polyesters, it being possible for the latter to comprise, as synthesis components, hexahydrophthalic acid and/or methylhexahydrophthalic acid and also—in some cases optionally—neopentyl glycol, trimethylolpropane, other alkanediols, other dicarboxylic acids and also monocarboxylic and/or hydroxycarboxylic acids in defined proportions.

A disadvantage of the polyesters disclosed therein is that despite the comparatively low molecular weights the viscosities in solution are very high.

EP 1 334 989 describes the preparation of branched polyesterols of low viscosity for paint applications for increasing the nonvolatiles fraction. In this case mixtures of difunctional carboxylic acids and carboxylic acids of higher functionality (the functionality of the mixture being at least 2.1) are reacted with trifunctional alcohols and aliphatic branched monocarboxylic acids. The polyesters described are to be regarded as branched; however, the essential thing here is seen as being the use of branched monocarboxylic acids, which greatly reduce the viscosity of the system but also increase the unreactive fraction of the polyester.

Polyesters of high functionality and defined construction are a relatively recent phenomenon. Thus WO 93/17060 (EP 630 389) and EP 799 279 describe dendrimeric and hyperbranched polyesters based on dimethylolpropionic acid, which as an AB₂ unit (A=acid group, B=OH group) undergo intermolecular condensation to form polyesters. The synthesis is highly inflexible, since it relies on AB₂ units such as dimethylolpropionic acid as the sole ingredient. Moreover, dendrimers are too costly for general use, since the AB₂ unit ingredients are already generally expensive, the syntheses are multistage, and exacting requirements are imposed on the purity of the intermediate and end products.

WO 01/46296 describes the preparation of dendritic polyesters in a multistage synthesis starting from a central molecule, such as trimethylolpropane, dimethylolpropionic acid as the AB₂ unit, and also a dicarboxylic acid or a glycidyl ester as functionalizing agents. This synthesis likewise relies on the presence of the AB₂ unit.

WO 03/070843 and WO 03/070844 describe hyperbranched copolyester polyols based on AB₂ or else AB₃ units and a chain extender, and used in coatings systems. Examples of ingredients used include dimethylolpropionic acid and caprolactone. Here again one is dependent on an AB₂ unit.

EP 1109775 describes the preparation of hyperbranched polyesters having a tetrafunctional central group. In this case, starting from asymmetric tetraols, such as homopentaerythritol, as the central molecule a dendrimerlike product is synthesized which is used in paints. Asymmetric tetraols of this kind, however, are expensive specialty chemicals which are not available commercially in large quantities.

EP 1070748 describes the preparation of hyperbranched polyesters and their use in powder coating materials. The esters, again based on autocondensable monomers such as dimethylolpropionic acid as the AB₂ unit, are added, after chain extension if appropriate, to the coating system as flow improvers, in amounts of 0.2%-5% by weight.

DE 101 63 163 and DE 10219508 describe the preparation of hyperbranched polyesters based on an A₂+B₃ approach. The basis for this principle is to use dicarboxylic acids and triols or tricarboxylic acids and diols. The flexibility of these syntheses is much higher, since one is not reliant on the use of an AB₂ unit.

Nevertheless it was desirable to increase further the flexibility of the synthesis to give highly branched or hyperbranched polyesters, specifically in connection with the setting of functionalities, solubility behaviors and also melting or glass transition temperatures.

R. A. Gross and coworkers describe syntheses of branched polyesters by reacting dicarboxylic acids with glycerol or sorbitol and aliphatic diols. These syntheses are carried out by means of enzymatic catalysis and lead to “soft” products having a glass transition temperature of between −28° C. and 7° C.: see Polym. Prep. 2003, 44(2), 635, Macromolecules 2003, 36, 8219 and Macromolecules 2003, 36, 9804. The reactions involve enzyme catalysis and generally have long reaction times, which significantly lowers the space/time yield of the reaction and raises the costs for preparing polyesters. Furthermore, only certain monomers, adipic acid, succinic acid, glycerol, sorbitol or octanediol for example, can be reacted with enzymes, while products such as phthalic acids, trimethylolpropane or cyclohexanediol are difficult if not impossible to bring to reaction enzymatically.

The use of highly branched or hyperbranched polyesters in printing inks and printing systems is described in WO 02/36697 or WO 03/93002.

WO 2005/118677 discloses hyperbranched polyesters which have an acid number of at least 18 mg KOH/g.

A disadvantage of the highly branched or hyperbranched polyesters disclosed in the prior art is either that they are based on complex specialty monomers of type AB_{y} or AₓB (with x or y>1), which brings commercial disadvantages and restricts the variability in properties, or that, with the definitive use of A₂+B_{y} or Aₓ+B₂ monomers, they always carry an inherent risk of gelling and crosslinking. This inherent potential for gelling and crosslinking limits both the attractiveness of their preparation and the range of their possible applications.

WO 2005/118677 describes hyperbranched polyesters which have a low degree of crosslinking and avoid a large proportion of the disadvantages known from the prior art. However, even with the preparation method described therein, it is not possible to rule out gelling or crosslinking.

The object of the invention was to provide, by means of a technically simple process, highly branched and hyperbranched polyesters whose composition and properties are readily variable and adaptable and which at the same time, as compared with the prior art, have a reduced tendency toward gelling or crosslinking.

Surprisingly it has been found that, with retention of the broad variability of the polyester composition, in other words of the molecular parent units which definitively derive from di-, tri- or polycarboxylic acids and di-, tri-, tetra- or polyols and also monocarboxylic acids, monoalcohols, and hydroxycarboxylic acids, it is possible to prepare highly branched or hyperbranched polyesters which do not gel under reaction conditions, if the stoichiometric relationships between the constituent monomers, and/or the maximum allowable conversion, are set in a particular way. The inventive selection has proven nontrivial and is also not apparent from the prior art to a person skilled in the art.

With the polyesters of the invention it is possible to adapt molecular structures, degrees of branching, end group functionalities, glasslike character, softening temperatures, solubilities and dispersibilities, melting viscosities and dissolution viscosities, and optical properties to the requirements of the application within wide ranges and at the same time to obtain the advantageous properties of polymers possessing finite molar masses and extents.

The stoichiometric proportions of the molecular parent units that are found again in the polyester are represented in this specification on the basis that the polyester is, notionally, broken down hydrolytically into its constituent monomers, i.e., mono-, di-, tri- or polycarboxylic acids, mono-, di-, tri-, tetra- or polyols, and also, if appropriate hydroxycarboxylic acids. In the context of this specification, therefore, A is used for molecular parent units of the polyester that derive from carboxyl groups, and B for those which derive from hydroxyl groups.

A₁ identifies units which derive from monocarboxylic acids or their derivatives; Aₓ identifies units from carboxylic acids with a carboxyl functionality of more than one, i.e., A₂ from dicarboxylic acids, A₃ from tricarboxylic acids, Aₓ₊ from polycarboxylic acids with a carboxyl functionality of four or more. B₁ stands, analogously, for units deriving from monofunctional alcohols; B₂ from diols, B₃ from triols, B₄ from tetraalcohols, B_{y+} from polyols having a hydroxyl functionality of five or more. AB, AₓB, AB_{y}, and AₓB_{y} stand for structures which derive from corresponding hydroxycarboxylic acids.

The conversion referred to in this specification relates always to that functionality (carboxyl or hydroxyl functionality) which is present in a deficit (substoichiometric) amount in the product or in the reaction mixture, respectively. Where the conversion approaches 100%, the polyester of the invention by definition no longer has any free end groups of the deficit functionality. At 0% conversion, the polyester is notionally broken down hydrolytically completely into its constituent monomers, i.e., mono-, di-, tri- or polycarboxylic acids, mono-, di-, tri-, tetra- or polyols (and also, if appropriate, hydroxycarboxylic acids).

The inventive selection in terms of the stoichiometry and/or conversion is made on the basis of the average functionality f.A of the molecular units A deriving from carboxylic acids and also on the basis of the average functionality f.B of the molecular units B deriving from alcohols. Furthermore, the inventive selection is made on the basis of the mole fraction x.A of the groups deriving from carboxylic acids. Selection criteria are the following definitions and limits:

1. For the average functionalities f.A and f.B the selection criterion in accordance with the invention is as follows:
f.A+f.B>4, preferably f.A+f.B≧4.5, more preferably f.A+f.B≧5
with f.A≧2 and f.B≧2 or
with f.A>2 and f.B≧f.A/(f.A−1) or
with f.A≧f.B/(f.B−1) and f.B>2
   where
   average functionality of the carboxylic acids f.A≡(Σᵢ n.Aᵢ f.Aᵢ)/(Σᵢ n.Aᵢ)
   average functionality of the alcohols f.B≡(Σₖ n.Bₖ f.Bₖ)/(Σₖ n.Bₖ)
      with n.Aᵢ as the amount of substance of the carboxylic acids i in mol
      with f.Aᵢ as the carboxylic acid functionality per molecule Aᵢ,
      with f.Aᵢ being a positive number, for example from 1 to 8,
      preferably 1 to 4, more preferably 2,
      with n.Bₖ as the amount of substance of the alcohols k in mol
      with f.Bₖ as the hydroxyl functionality per molecule Bₖ,
      with f.Bₖ being a positive number, for example from 1 to 8,
      preferably 1 to 5, more preferably 1 to 4, very preferably 2 to 4, and in particular 2 to 3,
      with i and k independently of one another as an integral serial number for the structural elements in the polyester that derive from the monomers,
      preferably the functionality combinations
         either
         f.Aᵢ=1, 2, 3 or 4 and f.Bₖ=1 or 2, or
         f.Aᵢ=1 or 2 and f.Bₖ=1, 2, 3 or 4,
      with particular preference either
         f.Aᵢ=3 or 4 and f.Bₖ=2, or
         f.Aᵢ=2 and f.Bₖ=3 or 4
            2. For the composition of the polyester, each ester function being notionally hydrolyzed into one carboxyl group and one hydroxyl group, the selection criterion is as follows:

### f.A/[(f.A*f.B)+f.A]≦x.A≦(f.A*f.B)/[(f.A*f.B)+f.B]

with x.A+x.B=1
where
   mole fraction x.A of the carboxylic acid functionality
   x.A≡Σᵢ n.Aᵢ f.Aᵢ/[Σ_{i,k} (n.Aᵢ f.Aᵢ+n.Bₖ f.Bₖ)]
   mole fraction x.B of the alcohol functionality
   x.B≡Σₖ n.Bₖ f.Bₖ/[Σ_{i,k} (n.Aᵢ f.Aᵢ+n.Bₖ f.Bₖ)]

In the context it is possible to differentiate between different embodiments of the invention, which are set out and elucidated in greater detail below.

Depending on the composition of the polymers of the invention it is possible to distinguish between the following four cases:
2a) f.A/[(f.A*f.B)+f.A]≦x.A≦f.A/[f.A+(f.A−1)*f.B]
2b) f.A/[f.A+(f.A−1)*f.B]]<x.A≦0.5
2c) 0.5<x.A≦[(f.B−1)*f.A]/[f.B+(f.B−1)*f.A]
2d) [(f.B−1)*f.A]/[f.B+(f.B−1)*f.A]<x.A≦[f.A*f.B]/[(f.A*f.B)+f.B]

The inventive selection in terms of the conversion is guided not only by the average functionalities f.A and f.B but also by the composition of the polyester x.A (or x.B) in such a way that the following definitions and limits apply:

3. For the degree of conversion, U, of the deficit functionality the selection criterion which applies is
U.min≦U≦U.max,
where
for x.A≦0.5, i.e., cases 2a) and 2b)
U.min=(0.5−x.A)/{0.5−f.A/[(f.A*f.B)+f.A]}*100%,
and where
for x.A>0.5, i.e., cases 2c) and 2d)
U.min=(x.A−0.5)/{[f.A*f.B]/[(f.A*f.B)+f.B]−0.5}*100%,
and where
for f.A/[(f.A*f.B)+f.A]<x.A≦f.A/[f.A+(f.A−1)*f.B], i.e., case 2a)
U.max=99.99%,
for f.A/[f.A+(f.A−1)*f.B]]<x.A≦0.5, i.e., case 2b)
U.max=[2/f.max+(0.5−x.A)/{0.5−(f.A)/[f.A+(f.A−1)*f.B]}*(1−2/f.max)]*100%,
for 0.5<x.A≦[(f.B−1)*f.A]/[f.B+(f.B−1)*f.A], i.e., case 2c)
U.max=[2/f.max+(x.A−0.5)/{[f.A*(f.B−1)]/[f.B+f.A*(f.B−1)]−0.5}*(1−2/f.max)]*100%,
for [(f.B−1)*f.A]/[f.B+(f.B−1)*f.A]<x.A≦[f.A*f.B]/[(f.A*f.B)+f.B], case 2d)
U.max=99.99%, and
   f.max=f.A if f.A≧f.B or
   f.max=f.B if f.A<f.B

The degree of conversion, U, of the functionality that is present in a deficit amount in each case, as used here, differs from the typical conversion of a reaction mixture in that the variables recited above are calculated only with consideration of the ester, hydroxyl, and carboxylic acid groups that are present in the product, without employing the original reaction mixture from which this polyester was formed. In many cases, typically if the composition of the reaction mixture does not change apart from as a result of the removal of water of reaction, the degree of conversion U in this specification can be equated with the customary conversion concept.

For the degree of conversion U as used herein, the polyester is notionally hydrolyzed, and the total amount of the carboxyl groups is given by the number of free carboxyl end groups in the product plus the carboxyl groups from the ester groups. In a similar way, the overall hydroxyl group content is given by the number of free hydroxyl end groups of the product plus the hydroxyl groups from the ester groups. The degree of conversion U as used herein refers in each case to the functionality that is present in a deficit amount, in other words to the smaller of the two values, when the total carboxyl group content is compared with the total hydroxyl group content.

In accordance with the invention a nongelled noncrosslinked branched polyester of finite molar mass is obtained when the following composition is maintained (case 2a): f.A/[(f.A*f.B)+f.A]≦x.A≦f.A/[f.A+(f.A−1)*f.B]*K₂ₐ with K₂ₐ=100%, preferably with K₂ₐ=99.9%, more preferably K₂ₐ=99%, more preferably K₂ₐ=98%, more preferably K₂ₐ=95%, more preferably K_{2d}=90%, preferably K₂ₐ=85%.

In accordance with the invention a nongelled noncrosslinked branched polyester of finite molar mass is obtained when the composition maintained is as follows (case 2d): K_{2d}*[(f.B−1)*f.A]/[f.B+(f.B−1)*f.A] 5<x.A≦[f.A*f.B]/[(f.A*f.B)+f.B] with K_{2d}=100%, preferably K_{2d}=100.1%, more preferably K_{2d}=101%, more preferably K_{2d}=102%, more preferably K_{2d}=105%, more preferably K_{2d}=110%, preferably K_{2d}=115%.

In accordance with the invention a nongelled noncrosslinked branched polyester of finite molar mass is obtained when, in the case of the composition f.A/[f.A+(f.A−1)*f.B]<x.A≦0.5, the following restriction on conversion is observed (case 2b): U<[2/f.max+(0.5−x.A)/{0.5−(f.A)/[f.A+(f.A−1)*f.B]}*(1−2/f.max)]*100%*L_{2b} with L_{2b}=100%, preferably with L_{2b}=99.9%, more preferably L_{2b}=99%, more preferably L_{2b}=98%, more preferably L_{2b}=95%, more preferably L_{2b}=90%, more preferably L_{2b}=85%.

In accordance with the invention a nongelled noncrosslinked branched polyester of finite molar mass is obtained when, in the case of the composition 0.5<x.A≦[(f.B−1)*f.A]/[f.B+(f.B−1)*f.A], the following restriction on conversion is observed (case 2c): U<[2/f.max+(x.A−0.5)/{[f.A*(f.B−1)]/[f.B+f.A*(f.B−1)]−0.5}*(1−2/f.max)]*100%*L_{2c} with L_{2c}=100%, preferably with L_{2c}=99.9%, more preferably L_{2c}=99%, more preferably L_{2c}=98%, more preferably L_{2c}=95%, more preferably L_{2c}=90%, more preferably L_{2c}=85%.

In accordance with the invention a nongelled, noncrosslinked branched polyester of finite molar mass is obtained when, for the composition (limiting range case 2a) x.A=f.A/[f.A+(f.A−1)*f.B]*K₂ₐ or (limiting range case 2d) K_{2d}*[(f.B−1)*f.A]/[f.B+(f.B−1)*f.A]=x.A, the following restriction on conversion is observed: U=99.99%*L_{2ad} with L_{2ad}=100%, preferably with L_{2ad}=99.9%, more preferably L_{2ad}=99%, more preferably L_{2ad}=98%, more preferably L_{2ad}=95%, preferably L_{2ad}=90%, preferably L_{2ad}=85%.

Given a known formulation, the typical variables of polyester analysis that are familiar to a person skilled in the art, examples being the determination of the ester number, acid number, and hydroxyl number in accordance with DIN 53240-2 (October 1998), are generally suitable for ascertaining whether a highly branched or hyperbranched polyester satisfies the above selection criteria.

The examples demonstrate the physical designing of the polyesters of the invention and serve additionally to illustrate the apparently complicated but in practice simple establishment of the inventive selection criteria.

Additionally, polyesters which contain a small extent, preferably less than 10 mol %, more preferably 0 mol %, of structures (AB, AₓB, AB_{y}, AₓB_{y}) which derive from hydroxycarboxylic acids or lactones, are claimed in accordance with the invention, provided that functionality, composition, and conversion satisfy—analogously—the selection criteria described.

Where building blocks AB, AₓB, AB_{y} or AₓB_{y} of this kind are present, it is necessary to take into account the overall functionality in respect of branching potential and the individual functionalities in respect of the carboxyl-to-hydroxyl group ratio. By way of example, 3 mol % of a dihydroxycarboxylic acid AB₂ can be considered in the above calculation as 1 mol % tricarboxylic acid A₃ and 2 mol % triol B₃.

Examples of monomers from which the polyesters of the invention can be prepared are as follows:

The monocarboxylic acids (A₁) include for example acetic acid, propionic acid, n-, iso- or tert-butyric acid, valeric acid, trimethyl acetic acid, caproic acid, caprylic acid, heptanoic acid, capric acid, pelargonic acid, lauric acid, myristic acid, palmitic acid, montanic acid, stearic acid, oleic acid, ricinoleic acid, linoleic acid, linolenic acid, erucasic acid, fatty acids from soya, linseed, castor, and sunflower, isostearic acid, nonanoic acid, isononanoic acid, 2-ethylhexanoic acid, α,α-dimethyloctanoic acid, α,α-dimethylpropanoic acid, benzoic acid, and unsaturated monocarboxylic acids such as acrylic or methacrylic acid, or commercially customary mixtures such as Versatic® acids or Koch® acids.

The monocarboxylic acids can be used either as such or in the form of derivatives.

Where unsaturated carboxylic acids or their derivatives are used as monocarboxylic acids A₁, it can be rational to operate in the presence of commercially customary polymerization inhibitors.

The dicarboxylic acids (A₂) include for example aliphatic dicarboxylic acids, such as oxalic acid, malonic acid, succinic acid, glutaric acid, adipic acid, pimelinic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid.

It is also possible additionally to use aromatic dicarboxylic acids, such as phthalic acid, isophthalic acid or terephthalic acid, for example. Unsaturated dicarboxylic acids as well, such as maleic acid, fumaric acid or itaconic acid, can be used. It is also possible to employ dicarboxylic acids carrying further functional groups not disruptive to the esterification, such as, for example, 5-sulfoisophthalic acid, its salts and derivatives. A preferred example hereof is the sodium salt of dimethyl 5-sulfoisophthalate. Said dicarboxylic acids may also be substituted by one or more radicals selected from C₁-C₁₀ alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, trimethylpentyl, n-nonyl or n-decyl, for example,

C₃-C₁₂ cycloalkyl groups, such as cyclopropyl, cyclobutyl, cyclopentyl, cyclohexyl, cycloheptyl, cyclooctyl, cyclononyl, cyclodecyl, cycloundecyl and cyclododecyl, for example; preference is given to cyclopentyl, cyclohexyl and cycloheptyl;
alkylene groups such as methylene or ethylidene or
C₆-C₁₄ aryl groups such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, for example, preferably phenyl, 1-naphthyl and 2-naphthyl, more preferably phenyl.

Exemplary representatives of substituted dicarboxylic acids that may be mentioned include the following: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

It is also possible to use mixtures of two or more of the aforementioned dicarboxylic acids.

The dicarboxylic acids can be used either as such or in the form of derivatives.

By derivatives are meant preferably
the corresponding anhydrides in monomeric or else polymeric form,
monoalkyl or dialkyl esters, preferably mono- or di-C₁-C₄ alkyl esters, more preferably monomethyl or dimethyl esters or the corresponding monoethyl or diethyl esters,
additionally monovinyl and divinyl esters, and also
mixed esters, preferably mixed esters with different C₁-C₄ alkyl components, more preferably mixed methyl ethyl esters.

C₁-C₄ alkyl for the purposes of this specification means methyl, ethyl, isopropyl, n-propyl, n-butyl, isobutyl, sec-butyl and tert-butyl, preferably methyl, ethyl and n-butyl, more preferably methyl and ethyl and very preferably methyl.

Within the context of the present invention it is also possible to use a mixture of a dicarboxylic acid and one or more of its derivatives. Likewise possible within the context of the present invention is to use a mixture of two or more different derivatives of one or more dicarboxylic acids.

Particular preference is given to using malonic acid, succinic acid, glutaric acid, adipic acid, 1,2-, 1,3- or 1,4-cyclohexanedicarboxylic acid (hexahydrophthalic acids), phthalic acid, isophthalic acid, terephthalic acid or the monoalkyl or dialkyl esters thereof.

Examples of tricarboxylic acids (A₃), tetracarboxylic acids (A₄) or polycarboxylic acids (AxAₓ) that can be reacted include aconitic acid, 1,3,5-cyclohexanetricarboxylic acid, 1,2,4-benzenetricarboxylic acid, 1,3,5-benzenetricarboxylic acid, 1,2,4,5-benzenetetracarboxylic acid (pyromellitic acid) and also mellitic acid and low molecular weight polyacrylic acids.

Tricarboxylic acids (A₃), tetracarboxylic acids (A₄) or polycarboxylic acids (Aₓ₊) can be used in the process of the invention either as such or else in the form of derivatives.

By derivatives are meant preferably
the corresponding anhydrides in monomeric or else polymeric form,
mono-, di- or trialkyl esters, preferably mono-, di- or tri-C₁-C₄ alkyl esters, more preferably mono-, di- or trimethyl esters or the corresponding mono-, di- or triethyl esters,
additionally mono-, di- and trivinyl esters, and also
mixed esters, preferably mixed esters having different C₁-C₄ alkyl components, more preferably mixed methyl ethyl esters.

Within the context of the present invention it is also possible to use a mixture of a tricarboxylic, tetracarboxylic or polycarboxylic acid and one or more of its derivatives, such as a mixture of pyromellitic acid and pyromellitic dianhydride, for example. It is likewise possible within the context of the present invention to use a mixture of two or more different derivatives of one or more tricarboxylic or polycarboxylic acids, such as a mixture of 1,3,5-cyclohexanetricarboxylic acid and pyromellitic dianhydride, for example.

The monoalcohols (B₁) include for example methanol, ethanol, isopropanol, n-propanol, n-butanol, isobutanol, sec-butanol, tert-butanol, ethylene glycol monomethyl ether, ethylene glycol monoethyl ether, 1,3-propanediol monomethyl ether, n-hexanol, n-heptanol, n-octanol, n-decanol, n-dodecanol (lauryl alcohol), 2-ethylhexanol, cyclopentanol, cyclohexanol, cyclooctanol, cyclododecanol, n-pentanol, stearyl alcohol, cetyl alcohol, and lauryl alcohol.

Diols (B₂) used in accordance with the present invention include for example ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, 1,2- and 1,3-cyclopentanediols, 1,2-, 1,3- and 1,4-cyclohexanediols, 1,1-, 1,2-, 1,3- and 1,4-bis(hydroxymethyl)cyclohexane, 1,1-, 1,2-, 1,3- and 1,4-bis(hydroxyethyl)-cyclohexane, neopentyl glycol, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H, n being an integer and n≧4 with a molar weight up to 2000 g/mol, polyethylene-polypropylene glycols, the sequence of the ethylene oxide or propylene oxide units being blockwise or random with a molar weight up to 2000 g/mol, polytetramethylene glycols, preferably with a molar weight of up to 5000 g/mol, poly-1,3-propanediols, preferably with a molar weight up to 5000 g/mol, polycaprolactones, or mixtures of two or more representatives of the above compounds. Either one or both hydroxyl groups in the abovementioned diols may be substituted by SH groups. Diols whose use is preferred are ethylene glycol, 1,2-propanediol, 1,3-propanediol, 1,4-butanediol, 1,5-pentanediol, 1,6-hexanediol, 1,8-octanediol, 1,2-, 1,3- and 1,4-cyclohexanediol, 1,3- and 1,4-bis(hydroxymethyl)cyclohexane, and diethylene glycol, triethylene glycol, dipropylene glycol and tripropylene glycol. Alcohols with a functionality of at least three (B₃, B₄, B_{y+}) include glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol or higher condensates of glycerol, di(trimethylolpropane), di(pentaerythritol), trishydroxymethyl isocyanurate, tris(hydroxyethyl) isocyanurate (THEIC), tris(hydroxypropyl) isocyanurate, inositols or sugars, such as glucose, fructose or sucrose, for example, sugar alcohols such as, for example, sorbitol, mannitol, threitol, erythritol, adonitol (ribitol), arabitol (lyxitol), xylitol, dulcitol (galactitol), maltitol, isomalt, polyetherols with a functionality of three or more, based on alcohols with a functionality of three or more and on ethylene oxide, propylene oxide and/or butylene oxide.

Particular preference is given here to glycerol, diglycerol, triglycerol, trimethylolethane, trimethylolpropane, 1,2,4-butanetriol, pentaerythritol, tris(hydroxyethyl) isocyanurate and also polyetherols thereof based on ethylene oxide and/or propylene oxide.

In one embodiment of the invention f.Aᵢ, i.e., the carboxylic acid functionality per molecule Aᵢ, and f.Bₖ, i.e., the hydroxyl functionality per molecule Bₖ, are positive integral numbers corresponding to the chemical structural formula. In one preferred embodiment of the invention, particularly if significant differences in reactivity occur between the functionalities within one molecule, account may additionally be taken of kinetic factors as a result of the differences between these functionalities. In that case

f.Aᵢ and f.Bₖ are positive fractional numbers, which are smaller than the nominal positive integral numbers in accordance with the structural formula, which represent effective functionalities and which in turn are functions of temperature, pressure, and other reaction conditions. For example, glycerol would have a nominal hydroxyl functionality of 3. However, since the secondary hydroxyl function has a lower reactivity than the primary hydroxyl function, the secondary hydroxyl function—depending on reaction conditions—will in effect participate to a lesser extent in the reaction. Thus glycerol would have an effective functionality of below 3—for example, 2.5 to less than 3. The exact effective functionalities can be determined under the reaction conditions employed.

Besides carboxyl or hydroxyl groups, the carboxylic acids A or alcohols B may possess further functional groups or functional elements, in which case an inventive polyester is obtained which has further functionalities other than carboxyl or hydroxyl groups.

Functional groups may for example additionally be ether groups, carbonate groups, urethane groups, urea groups, thiol groups, thioether groups, thioester groups, keto or aldehyde groups, trisubstituted amino groups, nitrile or isonitrile groups, carboxamide groups, sulfonamide groups, silane groups or siloxane groups, sulfonic, sulfenic or sulfinic acid groups, phosphonic acid groups, vinyl groups or allyl groups.

Effects of this kind can be achieved for example by addition of functionalized building blocks as compounds during the polycondensation, these building blocks carrying not only hydroxyl groups or carboxyl groups but also further functional groups or functional elements, such as mercapto groups, tertiary amino groups, ether groups, carbonyl groups, sulfonic acids or derivatives of sulfonic acids, sulfinic acids or derivatives of sulfinic acids, phosphonic acids or derivatives of phosphonic acids, phosphinic acids or derivatives of phosphinic acids, silane groups, siloxane groups. For modification with mercapto groups, for example, mercaptoethanol or thioglycerol can be used. Tertiary amino groups, for example, can be produced by incorporating N-methyldiethanolamine, N-methyldipropanolamine or N,N-dimethylethanolamine. Ether groups can be generated, for example, by incorporating polyetherols with a functionality of two or more as part of the condensation reaction.

The highly branched or hyperbranched polyesters of the invention have a glasslike character without pronounced crystallinity of the polyester framework. The invention also embraces highly branched or hyperbranched polyesters in which side chains crystallize, alkane radicals for example. The polyesters of the invention have a number-40 average molecular weight Mₙ of at least 500, preferably at least 750, and more preferably at least 1000 g/mol. The upper limit on the molecular weight Mₙ is preferably 100 000 g/mol, and with particular preference it amounts to not more than 50 000 and with very particular preference not more than 10 000 g/mol. The polyesters of the invention have a weight-average molecular weight M_{w} of at least 750, preferably at least 1500, and more preferably at least 2500 g/mol. The upper limit on the molecular weight M_{w} is preferably 500 000 g/mol; with particular preference it is not more than 100 000 and with very particular preference not more than 50 000 g/mol.

The figures relating to the number-average and weight-average molecular weight Mₙ and M_{w}, and the resulting polydispersity M_{w}/Mₙ, refer here to measurements made by gel permeation chromatography, using polymethyl methacrylate as a standard and tetrahydrofuran or hexafluoroisopropanol or dimethylacetamide as the eluent. The method is described in Analytiker Taschenbuch Vol. 4, pages 433 to 442, Berlin 1984.

The polydispersity of the polyesters of the invention is 1.2 to 50, preferably 2 to 40, more preferably 2.5 to 30, and very preferably up to 10.

The solubility of the polyesters of the invention is typically very good; that is, clear solutions at 25° C. can be prepared with an amount of up to 50% by weight, in some cases even above 80% by weight, of the polyesters of the invention in tetrahydrofuran (THF), ethyl acetate, n-butyl acetate, methyl ethyl ketone, acetone, ethanol or other solvents or solvent mixtures, without gel particles being visible to the naked eye. Even on microfiltration, no degree of gelling is found for polyesters of the invention that is above that of a linear polyester of comparable molar mass M_{w}.

To investigate the relative degree of gelling of different polyesters, optically clear solutions (preferably: 5-30% by weight) are prepared in a suitable solvent (preferably: ethyl acetate, butyl acetate, methyl ethyl ketone, anhydrous acetone, less preferably: acetone/water mixtures, hexafluoroisopropanol, dichloroacetic acid). The dissolution process may take several hours and may if appropriate require elevated temperatures. A suitable volume (preferably: 5 to 50 ml) is forced under gentle pressure through a microfiltration membrane which is stable in the solvent used (preferably Teflon membrane with 10-20 μm pore size). The filter is dried and the polymer fraction remaining on the membrane is determined gravimetrically. If the filter becomes plugged during the filtration of the solution, the unfiltrable volumes are taken as a measure of the relative degree of gelling.

The highly branched and hyperbranched polyesters of the invention may be carboxyl-terminated, carboxyl- and hydroxyl-terminated, or hydroxyl-terminated. Terminal carboxyl groups may be present in the form of free carboxylic acids, of neutralized carboxylic salts or of typical reaction products (e.g., with epoxides).

In one preferred embodiment of the invention the polyesters are primarily hydroxyl-terminated. They can be used, for example, for producing, for example, adhesives, printing inks, coatings, foams, coverings, and paints, with advantage.

In another preferred embodiment of the invention the polyesters are primarily carboxyl-terminated. They can be used with advantage, for example, in aqueous and nonaqueous dispersions and also surface coatings.

The invention further provides processes for preparing the polyesters of the invention under the boundary conditions of the invention. The processes of the invention can be carried out in bulk or in the presence of a solvent. In one preferred embodiment the reaction is carried out free from solvent.

To carry out the process of the invention it is possible to operate in the presence of a water-removing agent, as an additive added at the beginning of the reaction. Suitable examples include molecular sieves, especially molecular sieve 4 Å, MgSO₄ and Na₂SO₄. It is also possible during the reaction to add further water remover or to replace water remover by fresh water remover.

For carrying out the process of the invention it is also possible to operate under distillative conditions and to remove water and/or alcohol formed during the reaction by thermal means. Distillation may take place under superatmospheric, atmospheric or subatmospheric pressure conditions. Besides distillation at or above the respective boiling point of the water, alcohol, or mixture, it is also possible to use a water separator, in which case the water is removed with the aid of an azeotrope former.

Separation may also take place by stripping: for example, by passing a gas which is inert under the reaction conditions through the reaction mixture, additionally, if appropriate, to a distillation. Suitable inert gases include preferably nitrogen, noble gases, carbon dioxide or combustion gases.

The process of the invention can be carried out in the absence of catalysts. It is preferred, however, to operate in the presence of at least one catalyst. The catalysts in question are the typical catalysts for esterification and transesterification reactions, of the kind familiar to a person skilled in the art.

Examples of such catalysts are on the one hand oxides, carboxylates, organometallic compounds, and complexes of antimony, bismuth, cobalt, germanium, titanium, zinc or tin, such as acetates, alkoxides, acetylacetonates, oxalates, laurates. Such catalysts are used in the typical concentrations. Typical concentrations are 3 to 1000 ppm of the catalyzing metal, based on the carboxylic acid monomers. Examples thereof are antimony(III) acetate, antimony(III) oxide, germanium(IV) oxide, freshly precipitated titanium hydroxide oxides TiO(OH)₂, and similar compositions, titanium tetrabutoxide Ti[O—C₄H₉]₄, titanium tetraisopropoxide Ti[O—CH(CH₃)₂]₄, potassium titanyl oxalate hydrate K₂TiO[C₂O₄]₂xH₂O, dibutyltin dilaurate Sn[C₄H₉]₂[OC₁₂H₂₅]₂, dibutyltin oxide Sn[C₄H₉]₂O, and similar compositions, tin (II) n-octanoate, tin(II) 2-ethylhexanoate, tin(II) laurate, dibutyltin oxide, diphenyltin oxide, dibutyltin dichloride, dibutyltin diacetate, dibutyltin dimaleate or dioctyltin diacetate.

Further examples are acidic organic catalysts such as organic compounds with, for example, carboxyl groups (also autocatalysis), phosphate groups, sulfonic acid groups, sulfate groups or phosphonic acid groups. Sulfonic acids, such as para-toluenesulfonic acid, for example, are particularly preferred. Acidic ion exchange resins can also be used as acidic organic catalysts, examples being polystyrene resins containing sulfonic acid groups and crosslinked with approximately 2 mol % of divinylbenzene.

Further examples are acidic inorganic catalysts. Examples are sulfuric acid, sulfates and hydrogen sulfates, such as sodium hydrogen sulfate, phosphoric acid, phosphonic acid, hypophosphorous acid, aluminum sulfate hydrate, alum, acidic silica gel (pKₛ<6, especially ≦5) and acidic aluminum oxide.

Further acidic inorganic catalysts which can be used include, for example, aluminum compounds of the general formula Al(OR¹)₃ and titanates of the general formula Ti(OR¹)₄, it being possible for the radicals R¹ to be identical or different in each case, the radicals R′ being selected independently of one another from:

C₁-C₂₀ alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, n-decyl, n-dodecyl, n-hexadecyl or n-octadecyl, for example,
C₃-C₁₂ cycloalkyl radicals, such as cyclopropyl, cyclobutyl, cyclopentyl, cyclohexyl, cycloheptyl, cyclooctyl, cyclononyl, cyclodecyl, cycloundecyl and cyclododecyl, for example; preferably cyclopentyl, cyclohexyl and cycloheptyl.

The radicals R¹ in Al(OR¹)₃ and/or Ti(OR¹)₄ are preferably each identical and selected from n-butyl, isopropyl and 2-ethylhexyl.

Preferred acidic organometallic catalysts are selected for example from dialkyltin oxides R¹₂SnO or dialkyltin esters R¹₂Sn(OR²)₂, in which R¹ is as defined above and can be identical or different.

R² can have the same definitions as R¹ and additionally can be C₆-C₁₂ aryl: phenyl, o-, m- or p-tolyl, xylyl or naphthyl, for example. R² can in each case be identical or different.

Examples of organotin catalysts are tin(II) n-octanoate, tin(II) 2-ethylhexanoate, tin(II) laurate, dibutyltin oxide, diphenyltin oxide, dibutyltin dichloride, dibutyltin diacetate, dibutyltin dilaurate, dibutyltin dimaleate or dioctyltin diacetate.

Particularly preferred representatives of acidic organometallic catalysts are dibutyltin oxide, diphenyltin oxide and dibutyltin dilaurate.

In addition it is possible to make use for example of transesterification catalysts such as oxides, carboxylates, organometallic compounds, and complexes of manganese, cobalt, zinc, calcium or magnesium, such as acetates, alkoxides, oxalates. Such catalysts are used at the typical concentrations. Typical concentrations are 5 to 500 ppm of the catalyzing metal, based on the carboxylic acid monomers. Examples thereof are manganese(II) acetate and magnesium acetate.

Combinations of two or more of the aforementioned catalysts can also be employed. A further possibility is to use organic or organometallic or else inorganic catalysts that are in the form of discrete molecules in an immobilized form, on silica gel or on zeolites, for example.

If it is desired to use acidic inorganic, organometallic or organic catalysts then the amount of catalyst used is in accordance with the invention from 0.1% to 10% by weight, preferably from 0.2% to 2% by weight.

Enzymes or their decomposition products are likewise included among the possible organic catalysts for the purposes of the present invention. Also the carboxylic acids can act as acidic organic catalysts for the purposes of the present invention, provided either the degree of conversion is limited or carboxyl groups are not a deficit component.

The process of the invention is carried out preferably under an inert gas atmosphere, i.e., a gas which is inert under the reaction conditions, such as under carbon dioxide, combustion gases, nitrogen or noble gas, for example, among which argon may be mentioned in particular.

The process of the invention is carried out at temperatures from 60 to 350° C. It is preferred to operate at very low temperatures, but above a temperature at which all of the components of the reaction mixture are in fluid form. In one preferred embodiment the procedure is carried out at temperatures above the boiling point of low molecular weight condensation products that are to be removed by distillation. In the case of aliphatic components and water to be removed by distillation, for example, operation takes place at temperatures from 80 to 250, more preferably at 100 to 200° C.

The pressure conditions of the process of the invention are not generally critical. They depend on the volatility of the ingredients, intermediates, and condensation products at the above-indicated reaction temperatures. The reaction for the preparation of the polyesters of the invention takes place preferably such that the condensation product (generally water or methanol) can easily be stripped off above the gas phase, and monomers and oligomers remain in the reaction mixture. It is possible to operate at pressures up to 10 bar, for example, at atmospheric pressure, or else under subatmospheric pressure. Preference may be given to processes under superatmospheric pressure, if for example the desired reaction temperature is above the boiling point of a monomer at atmospheric pressure. Preference may be given to processes under atmospheric pressure, if for example the mass transport in the gas phase is nonlimiting or if monomers or oligomers have a tendency to undergo sublimation or evaporation. In another embodiment of the invention, preference may be given to processes under reduced pressure, if for example the mass transport in the gas phase is limiting or monomers are to be stripped off for a controlled progress of the reaction. In these cases it is possible to operate at a markedly reduced pressure, at for example 3 to 500 mbar, more preferably below 50 mbar, and very preferably below 5 mbar.

Temperature and pressure can also be varied in the course of the reaction.

The reaction time of the process of the invention is normally from 10 minutes to 48 hours, preferably from 30 minutes to 24 hours.

In one embodiment of the process of the invention the solid or liquid starting substances a) and b), in bulk or in solution or suspension or emulsion in an appropriate solvent, are introduced into a heatable and stirrable reaction volume. The catalysts recited may be introduced into the reaction vessel individually or with one another, in bulk, in solution or in a mixture with suitable starting substances a) or b). The addition of the catalysts may be made at the beginning of the reaction or at any desired suitable point in time in the course of the reaction.

In a further embodiment of the process of the invention the starting substances a) and b) included in the initial charge to the reaction volume are heated with or without catalyst and, if appropriate, all of the components are brought into the liquid phase.

In a further embodiment of the process the reaction mixture is stirred at elevated temperatures in such a way that the surface of the reaction mixture undergoes continual renewal and allows the efficient discharge of low molecular mass condensation products, water or methanol for example.

In one preferred embodiment of the process the pressure and temperature profiles are selected such that the boiling point of the low molecular mass condensation products to be discharged is exceeded, but as far as possible there are no boiling delays, instances of local overheating, foam formation or uncontrolled splashing of the reaction mixture around the reaction volume.

In one preferred embodiment of the process the pressure and temperature profiles are selected such that the boiling point of the low molecular mass condensation products to be discharged is exceeded, but as far as possible no boiling point or sublimation point of starting substances or oligomers is reached.

In one embodiment of the process the composition of the reaction mixture remains constant throughout the period of reaction, with respect to the molecular units based on difunctional or higher polyfunctional carboxylic acids and on difunctional or higher polyfunctional alcohols.

In another embodiment of the process, throughout the period of the reaction, the composition of the reaction mixture does not remain constant with respect to the molecular units based on difunctional or higher polyfunctional carboxylic acids and on difunctional or higher polyfunctional alcohols. Here, for example, the composition can be modified by distillative removal of a diol or of a cyclic ether based on it.

In another embodiment of the process, throughout the period of the reaction, the composition of the reaction mixture does not remain constant with respect to the molecular units based on carboxylic acids and on alcohols. Here, for example, the composition can be modified by subsequent addition of an alcohol or of a carboxylic acid.

In one preferred embodiment the course of the reaction is monitored by means of noncontinuous or regular quasicontinuous or continuous measurement techniques. In one particularly preferred embodiment, for example, the course of the reaction is measured by determining the acid numbers of random samples, by determining the melt viscosity of random samples, or by continuously measuring the torque or the power consumption of a stirrer motor.

In one embodiment, after the end of reaction, the highly branched and hyperbranched polyesters of the invention can be supplied directly from the melt to a granulating operation. In another embodiment, after the reaction, the polyester of the invention can be admixed with solvents and converted into a solution or dispersion. The choice of preferred embodiment is guided by the way in which the product can be more effectively handled and stored, and by which form is advantageous for further use.

When the polyester of the invention is prepared in bulk it can be put to further use directly or subjected to secondary reactions.

When the polyester of the invention is prepared in solution it can be put to further use directly or else the polymer can be subjected to secondary reactions and/or can be isolated by removal of the solvent by stripping, the stripping of the solvent typically being conducted under reduced pressure, or by precipitation of the polymer, using water as a precipitant, for example. If appropriate, the polymer can be subsequently washed and dried.

Secondary reactions may for example be those reactions of the ester, carboxyl or hydroxyl groups that do not particularly alter the highly branched and hyperbranched structure of the polyester.

In one embodiment of the invention, free carboxylic acid functions are wholly or partly neutralized with bases. Bases suitable for this purpose may be secondary and tertiary amines such as morpholine, diethanolamine, triethanolamine, triethylamine, N,N-diethylethanolamine, N-methyldiethanolamine, and N,N-dimethylethanolamine, for example.

In another embodiment of the invention, free carboxylic acid functions are reacted fully or partly with epoxides. Examples of suitable epoxides include epoxidized olefins, glycidyl esters (e.g., glycidyl(meth)acrylate) of saturated or unsaturated carboxylic acids, or glycidyl ethers of aliphatic or aromatic polyols, and also glycidol. Further epoxides are, for example, unsubstituted or substituted alkylene oxides such as ethylene oxide and/or propylene oxide, epichlorohydrin, epibromohydrin, 2,3-epoxy-1-propanol, 1-allyloxy-2,3-epoxypropane, 2,3-epoxyphenyl ether, 2,3-epoxypropyl isopropyl ether, 2,3-epoxypropyl octyl ether or 2,3-epoxypropyltrimethylammonium chloride.

If appropriate in solution in a suitable solvent, the hyperbranched polyester with acid functionalities is introduced initially, at temperatures between 0° C. and 120° C., preferably between 10 and 100° C. and more preferably between 20 and 80° C., preferably under inert gas, such as nitrogen, for example. The alkylene oxide, which if appropriate is dissolved at a temperature of −30° C. to 50° C., is metered into this initial charge continuously or in portions, with thorough commixing, and at a rate such that the temperature of the reaction mixture is maintained between 120 and 180° C., preferably between 120 and 150° C. The reaction may take place under a pressure up to 60 bar, preferably up to 30 bar, and more preferably up to 10 bar.

If appropriate it is possible to add a catalyst for the purpose of acceleration.

After all of the alkylene oxide has been metered in, reaction is allowed to continue for generally 10 to 500 min, preferably 20 to 300 min, more preferably 30 to 180 min, at temperatures between 30 and 220° C., preferably 80 to 200° C., and more preferably 100 to 180° C., it being possible for the temperature to be constant or to be raised in stages or continuously.

The alkylene oxide conversion is preferably at least 90%, more preferably at least 95%, and very preferably at least 98%. Any residues of alkylene oxide can be stripped out by passing a gas—nitrogen, helium, argon or steam, for example—through the reaction mixture.

In a further embodiment of the invention, free hydroxyl functions are reacted wholly or partly with activated carboxylic acid derivatives. Suitable for this purpose, for example, are anhydrides, carbonyl halides, and esters, preferably methyl esters, and carbonates, such as, for example, succinic anhydride, maleic anhydride, phthalic anhydride, hydrophthalic anhydride and dimethyl carbonate and diethyl carbonate. With particular preference, mild reaction conditions are set in this case, and, in particular, relatively low reaction temperatures. It can be sensible to remove water formed during the reaction, using an azeotrope-forming solvent, such as n-pentane, n-hexane, n-heptane, cyclohexane, methylcyclohexane, benzene, toluene or xylene, for example. It can be sensible to catalyze the reaction, enzymatically for example.

In another embodiment of the invention, free hydroxyl functions are reacted wholly or partly with carboxylic acids C. Suitable for this purpose, for example, are the above-described monocarboxylic acids A₁. One preferred embodiment of the invention uses long-chain, branched aliphatic carboxylic acids, which lower the polarity and impact positively on the solvency of the polyesters. In another preferred embodiment of the invention, α,β-unsaturated carboxylic acids or their derivatives are used. To suppress polymerization in the reaction of α,β-unsaturated carboxylic acids or their derivatives it can be sensible to operate in the presence of commercially customary polymerization inhibitors, which are known per se to the skilled worker.

In another embodiment of the invention, free hydroxyl functions are modified wholly or partly by addition of molecules comprising isocyanate groups. Polyesters comprising urethane groups, for example, can be obtained by reaction with alkyl or aryl isocyanates.

In a further embodiment of the invention, free hydroxyl functions are modified wholly or partly by reaction with lactones (e.g., with ε-caprolactone).

The invention further provides for the uses of the polyesters of the invention.

The highly branched or hyperbranched polyesters of the invention, or those prepared in accordance with the invention, can be used with advantage industrially as, among other things, adhesion promoters, in printing inks for example, as rheology modifiers, as surface or interface modifiers, as functional polymer additives, as building blocks for preparing polyaddition or polycondensation polymers, for example paints, coverings, adhesives, sealants, casting elastomers or foams, and also as a constituent of binders, together if appropriate with other components such as, for example, isocyanates, epoxy-functional binders or alkyd resins, in adhesives, printing inks, coatings, foams, coverings and paints, dispersions, as surface-active amphoterics and in thermoplastic molding compounds.

In a further aspect the present invention provides for the use of the highly branched and hyperbranched polyesters of the invention for preparing polyaddition or polycondensation products, such as polycarbonates, polyurethanes, polyesters and polyethers, for example. Preference is given to using the hydroxy-terminated high-functionality highly branched and hyperbranched polyesters of the invention for preparing polycarbonates, polyesters or polyurethanes.

In another aspect the present invention provides for the use of the highly branched and hyperbranched polyesters of the invention and also of the polyaddition or polycondensation products prepared from high-functionality highly branched and hyperbranched polyesters as a component of printing inks, adhesives, coatings, foams, coverings and paints.

In another aspect the present invention provides printing inks, adhesives, coatings, foams, coverings and paints comprising at least one highly branched and hyperbranched polyester of the invention or comprising polyaddition or polycondensation products prepared from the highly branched and hyperbranched polyesters of the invention, these products being distinguished by outstanding performance properties.

In a further, preferred aspect the present invention provides for the use of the inventively prepared highly branched or hyperbranched polyesters in printing inks, especially packaging inks for flexographic and/or gravure printing, which comprise at least one inventively prepared highly branched or hyperbranched polyester, at least one solvent or a mixture of different solvents, at least one colorant, at least one polymeric binder and, optionally, further additives.

Within the context of the present invention the highly branched and hyperbranched polyesters of the invention can also be used in a mixture with other binders. Examples of further binders for such printing inks comprise polyvinylbutyral, nitrocellulose, polyamides, polyurethanes, polyacrylates or polyacrylate copolymers. A combination which has proven particularly advantageous is that of the highly branched and hyperbranched polyesters with nitrocellulose. The total amount of all the binders in printing inks is normally 5%-35% by weight, preferably 6%-30% by weight and more preferably 10%-25% by weight, based on the sum of all the constituents. The ratio of highly branched and hyperbranched polyester to the total amount of all the binders is normally in the range from 30% by weight to 100% by weight, preferably at least 40% by weight, but the amount of highly branched and hyperbranched polyester should not in general be below 3% by weight, preferably 4% by weight and more preferably 5% by weight relative to the sum of all the constituents of the printing ink.

A single solvent or else a mixture of two or more solvents can be used. Solvents suitable in principle include the customary solvents for printing inks, especially packaging inks. Particularly suitable as solvents for the printing ink of the invention are alcohols such as, for example, ethanol, 1-propanol, 2-propanol, ethylene glycol, propylene glycol, diethylene glycol, substituted alcohols such as ethoxypropanol and esters such as ethyl acetate, isopropyl acetate, and n-propyl or n-butyl acetate, for example. Water is also a suitable solvent in principle. Particularly preferred solvents are ethanol or mixtures composed predominantly of ethanol, and ethyl acetate. Among the solvents possible in principle the skilled worker will make an appropriate selection in accordance with the solubility properties of the polyester and with the desired properties of the printing ink. It is normal to use from 40% to 80% by weight of solvent relative to the sum of all the constituents of the printing ink. Colorants which can be used include the customary dyes and, preferably, customary pigments. It is of course also possible to use mixtures of different dyes or colorants, and also soluble organic dyes. It is usual to use from 5% to 25% by weight of colorant, relative to the sum of all the constituents.

Pigments, according to CD Römpp Chemie Lexikon—Version 1.0, Stuttgart/New York: Georg Thieme Verlag 1995, and referring to DIN 55943, are particulate, organic or inorganic, chromatic or achromatic colorants which are virtually insoluble in the application medium. Virtually insoluble here means a solubility at 25° C. of below 1 g/1000 g of application medium, preferably below 0.5, more preferably below 0.25, very preferably below 0.1, and in particular below 0.05 g/1000 g of application medium.

Examples of pigments comprise any desired systems of absorption pigments and/or effect pigments, preferably absorption pigments. There are no restrictions whatsoever imposed on the number and selection of the pigment components. They may be adapted as desired to the particular requirements, such as the desired impression of color, for example. It is possible, by way of example, for all of the pigment components of a standardized mixer paint system to form the basis.

By effect pigments are meant all pigments which exhibit a plate-shaped construction and impart specific decorative color effects to a surface coating. The effect pigments are, for example, all effect-imparting pigments which can typically be employed in vehicle finishing and industrial coating. Examples of such effect pigments are pure metal pigments; such as aluminum pigments, iron pigments or copper pigments; interference pigments, such as titanium dioxide-coated mica, iron oxide-coated mica, mixed oxide-coated mica (e.g., with titanium dioxide and Fe₂O₃ or titanium dioxide and Cr₂O₃), metal oxide-coated aluminum, or liquid-crystal pigments.

The coloring absorption pigments are, for example, typical organic or inorganic absorption pigments which can be used in the paint industry. Examples of organic absorption pigments are azo pigments, phthalocyanine pigments, quinacridone pigments, and pyrrolopyrrole pigments. Examples of inorganic absorption pigments are iron oxide pigments, titanium dioxide, and carbon black.

Dyes are likewise colorants and different from the pigments in their solubility in the application medium, i.e., they have a solubility at 25° C. of above 1 g/1000 g in the application medium.

Examples of dyes are azo, azine, anthraquinone, acridine, cyanine, oxazine, polymethine, thiazine, and triarylmethane dyes. These dyes may be employed as basic or cationic dyes, mordant, direct, disperse, ingrain, vat, metal complex, reactive, acid, sulfur, coupling or substantive dyes.

Coloristically inert fillers are all substances/compounds which on the one hand are coloristically inactive—that is, they exhibit low intrinsic absorption and have a refractive index similar to that of the coating medium—and, on the other hand, are capable of influencing the orientation (parallel alignment) of the effect pigments in the surface coating, i.e., in the applied paint film, in addition to properties of the coating or of the coating materials, such as hardness or rheology, for example. Specified below are inert substances/compounds which can be employed by way of example, but without restriction of the concept of coloristically inert, topology-influencing fillers to these examples. Suitable inert fillers meeting the definition may be, for example, transparent or semitransparent fillers or pigments, such as silica gels, blanc fixe, kieselguhr, talc, calcium carbonates, kaolin, barium sulfate, magnesium silicate, aluminum silicate, crystalline silicon dioxide, amorphous silica, aluminum oxide, microspheres, including hollow microspheres, made for example of glass, ceramic or polymers, with sizes of 0.1-50 μm for example. Further inert fillers which can be used are any desired solid inert organic particles, such as urea-formaldehyde condensation products, micronized polyolefin wax and micronized amide wax. The inert fillers may in each case also be employed in a mixture. Preferably, however, only one filler is employed in each case.

An exemplary printing ink may optionally comprise further additives and auxiliaries. Examples of additives and auxiliaries are fillers such as calcium carbonate, aluminum oxide hydrate or aluminum and/or magnesium silicate. Waxes raise the abrasion resistance and serve to enhance the lubricity. Examples are, in particular, polyethylene waxes, oxidized polyethylene waxes, petroleum waxes or ceresin waxes. Fatty acid amides can be used for increasing the surface smoothness. Plasticizers serve to enhance the elasticity of the dried film. Examples are phthalates such as dibutyl phthalate, diisobutyl phthalate, dioctyl phthalate, citric esters or esters of adipic acid. For dispersing the pigments it is possible to use dispersing assistants. In the case of the printing ink of the invention it is possible, advantageously, to do without adhesion promoters, although this is not intended to rule out the use of adhesion promoters. The total amount of all of the additives and auxiliaries normally does not exceed 20% by weight relative to the sum of all the constituents of the printing ink, and is preferably 0%-10% by weight.

Paints, printing inks or coating materials can be prepared in a way which is known in principle, by intensively mixing and/or dispersing the constituents in customary apparatus such as dissolvers, stirred ball mills or a triple-roll mill, for example. Advantageously a concentrated pigment dispersion is first prepared with a portion of the components and a portion of the solvent, and is subsequently processed further to the finished printing ink with additional constituents and further solvent.

In a further preferred aspect the present invention provides print varnishes which comprise at least one solvent or a mixture of different solvents, at least one polymeric binder and, optionally, further additives, at least one of the polymeric binders comprising a highly branched or hyperbranched high-functionality polyester of the invention, and also provides for the use of the print varnishes of the invention for priming, or as a protective varnish and for producing multilayer materials.

The print varnishes of the invention of course comprise no colorants, but apart from that have the same constituents as the printing inks of the invention already outlined. The amounts of the remaining components increase correspondingly.

Surprisingly, through the use of printing inks, especially packaging inks, and print varnishes with binders based on highly branched and hyperbranched polyesters, multilayer materials with outstanding adhesion between the individual layers are obtained. The addition of adhesion promoters is no longer necessary. Especially surprising is the fact that without adhesion promoters the results achievable are even better than if adhesion promoters are added. On polar films in particular, distinct improvements were achievable in terms of the adhesion.

The polyesters of the invention can be used as a binder component, in coating materials for example, together if appropriate with other hydroxyl-containing or amino-containing binders, such as with hydroxy(meth)acrylates (polyacrylate-ols), hydroxystyryl(meth)acrylates, linear or branched polyesters, polyethers, polycarbonates, melamine resins or urea-formaldehyde resins, for example, together with compounds that are reactive toward carboxyl and/or hydroxyl functions, such as with isocyanates, blocked isocyanates, epoxides, carbonates and/or amino resins, for example, preferably with isocyanates, epoxides or amino resins, more preferably with isocyanates or epoxides and very preferably with isocyanates.

Isocyanates are for example aliphatic, aromatic and cycloaliphatic di- and polyisocyanates having an average NCO functionality of at least 1.8, preferably from 1.8 to 6 and more preferably from 2 to 4, and also their isocyanurates, oxadiazinetriones, iminooxadiazinediones, ureas, biurets, amides, urethanes, allophanates, carbodiimides, uretonimines and uretdiones.

The diisocyanates are preferably isocyanates having 4 to 20 carbon atoms. Examples of customary diisocyanates are aliphatic diisocyanates such as tetramethylene diisocyanate, 1,5-diisocyanatopentane, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4- or 2,6-diisocyanato-1-methylcyclohexane, and also aromatic diisocyanates such as 2,4- or 2,6-tolylene diisocyanate and isomer mixtures thereof, m- or p-xylylene diisocyanate, 2,4′- or 4,4′-diisocyanatodiphenylmethane and isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Mixtures of said diisocyanates may also be present.

Suitable polyisocyanates include polyisocyanates containing isocyanurate groups, uretdione diisocyanates, polyisocyanates containing biuret groups, polyisocyanates containing amide groups, polyisocyanates containing urethane or allophanate groups, polyisocyanates comprising oxadiazinetrione groups or iminooxadiazinedione groups, carbodiimide- or uretonimine-modified polyisocyanates of linear or branched C₄-C₂₀ alkylene diisocyanates, cycloaliphatic diisocyanates having a total of 6 to 20 carbon atoms or aromatic diisocyanates having a total of 8 to 20 carbon atoms, or mixtures thereof.

The di- and polyisocyanates which can be employed preferably have an isocyanate group content (calculated as NCO, molecular weight=42) of from 1% to 60% by weight, based on the diisocyanate and polyisocyanate (mixture), preferably from 2% to 60% by weight and more preferably from 10% to 55% by weight.

Preference is given to aliphatic and/or cycloaliphatic di- and polyisocyanates, examples being the abovementioned aliphatic and/or cycloaliphatic diisocyanates, or mixtures thereof.

Particular preference is given to hexamethylene diisocyanate, 1,3-bis(isocyanatomethyl)cyclohexane, isophorone diisocyanate and di(isocyanatocyclohexyl)methane, very particular preference to isophorone diisocyanate and hexamethylene diisocyanate, and especial preference to hexamethylene diisocyanate.

Preference extends to
1) Isocyanurate-group-containing polyisocyanates of aromatic, aliphatic and/or cycloaliphatic diisocyanates. Particular preference here goes to the corresponding aliphatic and/or cycloaliphatic isocyanato-isocyanurates and, in particular, to those based on hexamethylene diisocyanate and isophorone diisocyanate. The present isocyanurates are, in particular, tris-isocyanatoalkyl and/or tris-isocyanatocycloalkyl isocyanurates, which represent cyclic trimers of the diisocyanates, or are mixtures with their higher homologues containing more than one isocyanurate ring. The isocyanato-isocyanurates generally have an NCO content of from 10% to 30% by weight, in particular from 15% to 25% by weight, and an average NCO functionality of from 2.6 to 4.5.
2) Uretdione diisocyanates containing aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates.
   The uretdione diisocyanates can be used in the formulations of the invention as a sole component or in a mixture with other polyisocyanates, especially those mentioned under 1).
3) Polyisocyanates containing biuret groups and aromatically, cycloaliphatically or aliphatically attached, preferably cycloaliphatically or aliphatically attached, isocyanate groups, especially tris(6-isocyanatohexyl)biuret or its mixtures with its higher homologues. These polyisocyanates containing biuret groups generally have an NCO content of from 18% to 23% by weight and an average NCO functionality of from 2.8 to 4.5.
4) Polyisocyanates containing urethane and/or allophanate groups and aromatically, aliphatically or cycloaliphatically attached, preferably aliphatically or cycloaliphatically attached, isocyanate groups, such as may be obtained, for example, by reacting excess amounts of hexamethylene diisocyanate or of isophorone diisocyanate with monohydric or polyhydric alcohols such as for example methanol, ethanol, isopropanol, n-propanol, n-butanol, isobutanol, sec-butanol, tert-butanol, n-pentanol, n-hexanol, n-heptanol, n-octanol, n-decanol, n-dodecanol (lauryl alcohol), 2-ethylhexanol, stearyl alcohol, cetyl alcohol, lauryl alcohol, ethylene glycol monomethyl ether, ethylene glycol monoethyl ether, 1,3-propanediol monomethyl ether, cyclopentanol, cyclohexanol, cyclooctanol, cyclododecanol or polyhydric alcohols as listed above for the polyesterols, or with mixtures of alcohols. These polyisocyanates containing urethane and/or allophanate groups generally have an NCO content of from 12% to 20% by weight and an average NCO functionality of from 2.5 to 4.5.
5) Polyisocyanates comprising oxadiazinetrione groups, derived preferably from hexamethylene diisocyanate or isophorone diisocyanate. Polyisocyanates of this kind comprising oxadiazinetrione groups can be prepared from diisocyanate and carbon dioxide.
6) Polyisocyanates comprising iminooxadiazinedione groups, preferably derived from hexamethylene diisocyanate or isophorone diisocyanate. Polyisocyanates of this kind comprising iminooxadiazinedione groups are preparable from diisocyanates by means of specific catalysts.
7) Carbodiimide-modified and/or uretonimine-modified polyisocyanates.

The polyisocyanates 1) to 7) can be used in a mixture, including if appropriate in a mixture with diisocyanates.

The isocyanate groups of the di- or polyisocyanates may also be in blocked form. Examples of suitable blocking agents for NCO groups include oximes, phenols, imidazoles, pyrazoles, pyrazolinones, triazoles, diketopiperazines, caprolactam, malonic esters or compounds as specified in the publications by Z. W. Wicks, Prog. Org. Coat. 3 (1975) 73-99 and Prog. Org. Coat 9 (1981), 3-28, by D. A. Wicks and Z. W. Wicks, Prog. Org. Coat. 36 (1999), 148-172 and Prog. Org. Coat. 41 (2001), 1-83 and also in Houben-Weyl, Methoden der Organischen Chemie, Vol. XIV/2, 61 ff. Georg Thieme Verlag, Stuttgart 1963.

By blocking or capping agents are meant compounds which transform isocyanate groups into blocked (capped or protected) isocyanate groups, which then, below a temperature known as the deblocking temperature, do not display the usual reactions of a free isocyanate group. Compounds of this kind with blocked isocyanate groups are commonly employed in dual-cure coating materials or in powder coating materials which are cured to completion via isocyanate curing.

Epoxide compounds are those having at least one, preferably at least two, more preferably from two to ten, epoxide group(s) in the molecule.

Suitable examples include epoxidized olefins, glycidyl esters (e.g., glycidyl (meth)acrylate) of saturated or unsaturated carboxylic acids or glycidyl ethers of aliphatic or aromatic polyols and also glycidol. Products of this kind are available commercially in large numbers. Particular preference is given to polyglycidyl compounds of the bisphenol A, F or B type and to glycidyl ethers of polyfunctional alcohols, such as that of butanediol, of 1,6-hexanediol, of glycerol and of pentaerythritol. Examples of polyepoxide compounds of this kind are Epikote® 812 (epoxide value: about 0.67 mol/100 g) and Epikote® 828 (epoxide value: about 0.53 mol/100 g), Epikote® 1001, Epikote® 1007 and Epikote® 162 (epoxide value: about 0.61 mol/100 g) from Resolution, Rütapox® 0162 (epoxide value: about 0.58 mol/100 g), Rütapox® 0164 (epoxide value: about 0.53 mol/100 g) and Rütapox® 0165 (epoxide value: about 0.48 mol/100 g) from Bakelite AG, and Araldit® DY 0397 (epoxide value: about 0.83 mol/100 g) from Vantico AG.

Carbonate compounds are those having at least one, preferably at least two, more preferably two or three, carbonate group(s) in the molecule, comprising preferably terminal C₁-C₂₀ alkyl carbonate groups, more preferably terminal C₁-C₄ alkyl carbonate groups, very preferably terminal methyl carbonate, ethyl carbonate or n-butyl carbonate.

Suitability is further possessed by compounds containing active methylol or alkylalkoxy groups, especially methylalkoxy groups, such as etherified reaction products of formaldehyde with amines, such as melamine, urea, etc., phenol/formaldehyde adducts, siloxane or silane groups and anhydrides, as described for example in U.S. Pat. No. 5,770,650.

Among the preferred amino resins, which are known and widespread industrially, particular preference goes to using urea resins and melamine resins, such as urea-formaldehyde resins, melamine-formaldehyde resins, melamine-phenol-formaldehyde resins or melamine-urea-formaldehyde resins.

Suitable urea resins are those which are obtainable by reacting ureas with aldehydes and which if appropriate may be modified.

Suitable ureas are urea, N-substituted or N,N′-disubstituted ureas, such as N-methyl-urea, N-phenylurea, N,N′-dimethylurea, hexamethylenediurea, N,N′-diphenylurea, 1,2-ethylenediurea, 1,3-propylenediurea, diethylenetriurea, dipropylenetriurea, 2-hydroxypropylenediurea, 2-imidazolidinone (ethyleneurea), 2-oxohexahydropyrimidine (propyleneurea) or 2-oxo-5-hydroxyhexahydropyrimidine (5-hydroxypropyleneurea).

Urea resins can if appropriate be partly or fully modified, by reaction for example with mono- or polyfunctional alcohols, ammonia and/or amines (cationically modified urea resins) or with (hydrogen)sulfites (anionically modified urea resins), particular suitability being possessed by the alcohol-modified urea resins.

Suitable alcohols for the modification are C₁-C₆ alcohols, preferably C₁-C₄ alkyl alcohol and especially methanol, ethanol, isopropanol, n-propanol, n-butanol, isobutanol and sec-butanol.

Suitable melamine resins are those which are obtainable by reacting melamine with aldehydes and which if appropriate may be fully or partly modified.

Particularly suitable aldehydes are formaldehyde, acetaldehyde, isobutyraldehyde and glyoxal.

Melamine-formaldehyde resins are reaction products from the reaction of melamine with aldehydes, examples being the abovementioned aldehydes, especially formaldehyde. If appropriate the resulting methylol groups are modified by etherification with the abovementioned monohydric or polyhydric alcohols. Additionally the melamine-formaldehyde resins may also be modified as described above by reaction with amines, aminocarboxylic acids or sulfites.

The action of formaldehyde on mixtures of melamine and urea or on mixtures of melamine and phenol produces, respectively, melamine-urea-formaldehyde resins and melamine-phenol-formaldehyde resins which can likewise be used in accordance with the invention.

The stated amino resins are prepared by conventional methods.

Examples cited in particular are melamine-formaldehyde resins, including monomeric or polymeric melamine resins and partly or fully alkylated melamine resins, urea resins, e.g., methylolureas such as formaldehyde-urea resins, alkoxyureas such as butylated formaldehyde-urea resins, but also N-methylolacrylamide emulsions, isobutoxymethylacrylamide emulsions, polyanhydrides, such as polysuccinic anhydride, and siloxanes or silanes, such as dimethyldimethoxysilanes, for example.

Particular preference is given to amino resins such as melamine-formaldehyde resins or formaldehyde-urea resins.

The paints in which the polyesters of the invention can be employed may be conventional solventborne basecoats, aqueous basecoats, substantially solvent-free and water-free liquid basecoats (100% systems), substantially solvent-free and water-free solid basecoats (powder coating materials, including pigmented powder coating materials) or substantially solvent-free powder coating dispersions, if appropriate with pigmentation (powder slurry basecoats). They may be thermally curable, radiation-curable or dual-cure systems, and may be self-crosslinking or externally crosslinking. Catalysts which can be used in the paint formulation may for example be zinc compounds; compounds of the metals of transition groups IV, V or VI (particularly of zirconium, vanadium, molybdenum or tungsten), aluminum compounds, or bismuth compounds.

After the reaction, in other words without further modification, the highly branched and hyperbranched polyesters formed by the process of the invention are terminated with hydroxyl groups and/or with acid groups. Their solvency is generally good or they can be readily dispersed in a variety of solvents, such as in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate or propylene carbonate, for example.

The conversion of acid functions is generally above 75%, usually above 80%, and frequently above 90%.

In one embodiment of the present invention the hyperbranched polyester is reacted with carbodiimides, preferably monomeric carbodiimide, examples being that based on TMXDI (tetramethylxylylene diisocyanate), with dicyclohexylcarbodiimide or N,N′-diisopropylcarbodiimide. Carbodiimides are sold for example under the following brand names: Stabaxol® 1 (Rhein Chemie Rheinau GmbH, Mannheim; Germany); Ucarlink® XL-29SE (DOW CHEMICAL COMPANY, Midland, Mich.; USA), Elastostab® H 01 (BASF AG; polymer), Carbodilite® grades Nisshinbo; hydrophilicized).

The polyesters obtainable in accordance with the invention generally have a glass transition temperature of from −40 to 100° C.

The glass transition temperature T_{g} is determined by the DSC method (differential scanning calorimetry) in accordance with ASTM 3418/82.

In one preferred embodiment of the present invention polyesters of the invention having a T_{g} of from −40 to 60° C. are used in printing inks, since in this case in particular the resulting printing ink exhibits good adhesion to the substrate in combination if appropriate with bond strength with respect to a top layer.

In one preferred embodiment of the present invention polyesters of the invention having a glass transition temperature T_{g} of at least 0° C. are used in coating materials and paints. This range of glass transition temperature is advantageous for achieving, for example, sufficient film hardness and chemical resistance.

In one further embodiment of the present invention polyesters of the invention having a glass transition temperature, T_{g}, of at least 0° C. are used in coating materials and paints in combination with polyesters of the invention which have a glass transition temperature T_{g} of below 0° C.

The polyesters of the invention can also be used in combination with other binders, such as noninventive polyesters, acrylates, polyurethanes, polyethers, polycarbonates or their hybrids.

### EXAMPLES

The glass transition temperature T_{g} is determined by the DSC method (differential scanning calorimetry) in accordance with ASTM 3418/82; the heating rate is preferably 10° C./min.

### Example 1

A 1 L four-neck flask equipped with stirrer, internal thermometer and water-cooled condensate remover was charged with 244.6 g (1.59 mol) of cyclohexane-1,2-dicarboxylic anhydride (HPAA) and 255.4 g (1.90 mol) of trimethylolpropane (TMP) and also with 150 mg of dibutyltin dilaurate. By means of a heating mantle, the mixture was heated first to 160° C. and then to 180° C. until distillate was no longer observed. Each time the distillation activity subsided, the temperature was raised. Under atmospheric pressure, after 60, 100, 180 and 235 min, approximately 0, 1.3 g, 12 g and 28 g of water were distilled off.

After cooling, the reaction product was obtained as a transparent solid, which gave a clear solution in n-butyl acetate without residue. The final sample had an acid number of 15.2 mg KOH/g of polymer and a hydroxyl number of 345.8 mg KOH/g of polymer.

In this example

the average carboxyl functionality is found to be f.A=n.A_{HPAA} f.A_{HPAA}/n.A_{HPAA}=2,
the average hydroxyl functionality is found to be f.B=n.B_{TMP} f.B_{TMP}/n.B_{TMP}=3
and therefore f.max=f.B=3.

Since under the chosen reaction conditions neither carboxylic acid, significantly, nor alcohol is separated from the reaction mixture, x.A is found to be as follows:

### x.A=n.A_{HPAA} f.A_{HPAA}/(n.A_{HPAA} f.A_{HPAA}+n.B_{TMP} f.B_{TMP})]=(1.59*2)/(1.59*2+1.90*3)=0.36.

With f.A/[f.A*f.B)+f.A]=2/[(2*3)+2]=0.25 and f.A/[f.A+(f.A−1)*f.B]=2/[2+(2−1)*3]=0.4, this composition illustrates case 2a).

Accordingly the minimum conversion for a polyester of the invention is U.min=(0.5−x.A)/{0.5−f.A/[(f.A*f.B)+f.A]}*100%=(0.5−0.36)/{0.5−2/[2*3+2]}*100%=56% and the maximum conversion is 99.99%. From the condensate values and the acid numbers and hydroxyl numbers it is found that the conversion is situated at approximately 90% of the carboxylic acid groups (deficit functionality). From GPC measurements in dimethylacetamide (DMAc) using linear PMMA standards, molar masses M.n of 800 g/mol and M.w of 2450 g/mol were found. In the DSC the polyester gave a glass transition at 19.8° C. with no crystalline melting enthalpies. The polyester of this inventive example was noncrosslinked and nongelled.

### Example 2

A 1 L four-neck flask equipped with stirrer, internal thermometer and water-cooled condensate remover was charged, in the same way as in Example 1, with 150.4 g (0.87 mol) of cyclohexane-1,4-dicarboxylic acid (CHDA), 134.7 g (0.87 mol) of cyclohexane-1,2-dicarboxylic anhydride (HPAA), 50.4 g (0.35 mol) of 1,4-bis(hydroxymethyl)cyclohexane (cyclohexane-1,4-dimethanol, CHDM), 140.7 g (1.05 mol) of 2-ethyl-2-hydroxymethyl-1,3-propanediol (trimethylolpropane, TMP) and 23.8 g (0.17 mol) of 2,2-bis(hydroxymethyl)-1,3-propanediol (pentaerithritol) and also with 150 mg of dibutyltin dilaurate.

By means of a heating mantle, the mixture was heated first to 160° C., then to 180° C., and finally to 200° C. Under atmospheric pressure, approximately 36 g of water were distilled off. After cooling, the reaction product was obtained as a transparent solid, which gave a clear solution in n-butyl acetate without residue.

The final sample had an acid number of 78.3 mg KOH/g of polymer and a hydroxyl number of 199.1 mg KOH/g of polymer.

In this example the average carboxyl functionality is found to be f.A=2, the average hydroxyl functionality is found to be f.B=2.9 and accordingly f.max=f.B=2.9.

Since under the chosen reaction conditions neither carboxylic acid nor alcohol, significantly, are separated off from the reaction mixture, x.A is found to be as follows: x.A=0.43.

With f.A/[f.A+(f.A−1)*f.B]=2/[2+(2−1)*2.9]=0.41, the composition illustrates case 2b).

Accordingly the minimum conversion for an inventive polyester is

U.min=(0.5−x.A)/{0.5−f.A/[(f.A*f.B)+f.A]}*100%=(0.5−0.43)/{0.5−2/[2*2.9+2]}*100%=27%
and the maximum conversion is
U.max=[2/f.max+(0.5−x.A)/{0.5−(f.A)/[f.A+(f.A−1)*f.B]}*(1−2/f.max)]*100%=[2/2.9+(0.5−0.43)/{0.5−2/[2+(1)*2.9]}*(1−2/2.9)]*100%=91.5%.

From the condensate values and the acid numbers and hydroxyl numbers it was found that the conversion is approximately 77% of the carboxylic acid groups (deficit functionality). From GPC measurements in DMAc, using linear PMMA standards, molar masses M.n of 1600 g/mol and M.w of 4000 g/mol were found. In the DSC the polyester gave a glass transition at 26.2° C., with no crystalline melting enthalpies. The polyester of this inventive example is noncrosslinked and nongelled.

### Example 3

### Comparative Example

A 1 L four-neck flask equipped with stirrer, internal thermometer and water-cooled condensate remover was charged, in the same way as in Example 1, with 298.5 g (1.73 mol) of cyclohexane-1,4-dicarboxylic acid (CHDA), 50.0 g (0.35 mol) of 1,4-bis(hydroxymethyl)cyclohexane (cyclohexane-1,4-dimethanol, CHDM), 127.9 g (0.95 mol) of 2-ethyl-2-hydroxymethyl-1,3-propanediol (trimethylolpropane, TMP) and 23.6 g (0.17 mol) of 2,2-bis(hydroxymethyl)-1,3-propanediol (pentaerithritol) and also with 150 mg of dibutyltin dilaurate.

By means of a heating mantle, the mixture was heated first to 160° C., then to 180° C., and finally to 200° C. Under atmospheric pressure, approximately 57 g of water were distilled off.

Even during the reaction there was such an increase in the viscosity of the melt that the product could only be discharged from the flask by mechanical means. After cooling, the reaction product was in the form of a transparent solid, which could not be dissolved in any common solvent but could only be swollen in hexafluoroisopropanol (HFIP).

In this example the average carboxyl functionality is found to be f.A=2, the average hydroxyl functionality is found to be f.B=2.88 and accordingly f.max=f.B=2.88.

Since under the chosen reaction conditions neither carboxylic acid nor alcohol, significantly, are separated off from the reaction mixture, x.A is found to be follows: x.A=0.45.

With f.A/[f.A+(f.A−1)*f.B]=2/[2+(2−1)*2.9]=0.41, the composition illustrates case 2b).

Accordingly the minimum conversion for an inventive polyester is U.min=(0.5−x.A)/{0.5−f.A/[(f.A*f.B)+f.A]}*100%=20.7% and the maximum conversion is

U.max=[2/f.max+(0.5−x.A)/{0.5−(f.A)/[f.A+(f.A−1)*f.B]}*(1−2/f.max)]*100%−86.5%.

From the condensate values and the acid numbers and hydroxyl numbers it is found that the conversion is approximately 90% of the carboxylic acid groups (deficit functionality).

The polyester of this example was gelled, possibly crosslinked, and does not correspond to the inventive selection.

### Example 4

A 1 L four-neck flask equipped with stirrer, internal thermometer and water-cooled condensate remover was charged, in the same way as in Example 1, with 301.0 g (1.75 mol) of cyclohexane-1,4-dicarboxylic acid (CHDA), 58.0 g (0.40 mol) of 1,4-bis(hydroxymethyl)cyclohexane (cyclohexane-1,4-dimethanol, CHDM), 117.3 g (0.87 mol) of 2-ethyl-2-hydroxymethyl-1,3-propanediol (trimethylolpropane, TMP) and 23.8 g (0.17 mol) of 2,2-bis(hydroxymethyl)-1,3-propanediol (pentaerithritol) and also with 150 mg of dibutyltin dilaurate.

By means of a heating mantle, the mixture was heated first to 160° C., then to 180° C., and finally to 200° C. Under atmospheric pressure, approximately 46 g of condensate were distilled off. Analysis of the condensate gave a water content >95%.

After cooling, the reaction product was obtained as a transparent solid, which gave a clear solution in n-butyl acetate without residue. The final sample had an acid number of 88.8 mg KOH/g of polymer and a hydroxyl number of 154.2 mg KOH/g of polymer.

From the condensate values and the acid numbers and hydroxyl numbers it is found that the degree of conversion in the polymer, in accordance with the above definition, is approximately 75% of the carboxylic acid groups (deficit functionality).

In this example it is the case that f.A=2, f.B=2.84, f.max=f.B=2.84, x.A=0.46, U.min=16.2% and U.max=83.7%.

The polyester of this inventive example was noncrosslinked and nongelled.

### Example 5

### Comparative Example

A 1 L four-neck flask equipped with stirrer, internal thermometer and water-cooled condensate remover was charged, in the same way as in Example 1, with 301.0 g (1.75 mol) of cyclohexane-1,4-dicarboxylic acid (CHDA), 29.0 g (0.20 mol) of 1,4-bis(hydroxymethyl)cyclohexane (cyclohexane-1,4-dimethanol, CHDM), 12.4 g (0.20 mol) of ethylene glycol, 117.3 g (0.87 mol) of 2-ethyl-2-hydroxymethyl-1,3-propanediol (trimethylolpropane, TMP) and 23.8 (0.17 mol) of 2,2-bis(hydroxymethyl)-1,3-propanediol (pentaerithritol) and also with 150 mg of dibutyltin dilaurate.

By means of a heating mantle, the mixture was heated first to 160° C., then to 180° C., and finally to 200° C. Under atmospheric pressure, approximately 54.1 g of condensate were distilled off. Analysis of the condensate gave a water content of 85% by weight with 15% by weight of ethylene glycol.

Even during the reaction there was such an increase in the viscosity of the melt that the product wound itself in the form of a gel around the stirrer. After cooling, the reaction product was in the form of a glasslike transparent solid, which did not dissolve in any common solvent.

The last melt sample prior to gelling exhibited a viscosity of 4000 mPas at 125°. The last melt sample prior to gelling had an acid number of 90.9 mg KOH/g of polymer and a hydroxyl number of 158.2 mg KOH/g of polymer.

From the acid numbers and hydroxyl numbers a conversion of approximately 75% was estimated, based on the monomer mixture employed. On the basis of the condensate values and the acid numbers and hydroxyl numbers, a degree of conversion in the polymer, according to the above definition, of approximately 75% of the carboxylic acid groups (minority functionality) was estimated.

The difference in progress in comparison to Example 4 is not trivial and is also not apparent to the skilled worker from the prior art. The example shows that, outside of the limits according to the invention, deleterious products are formed.

In this example it is the case, with estimation of the distillative loss of ethylene glycol, that f.A=2, f.B=3.03, f.max=f.B=3.03, x.A=0.50, U.min=2% and U.max=66.4%.

The polyester of this noninventive example is gelled and possibly crosslinked.

1. A nongelling and noncrosslinked, highly branched or hyperbranched polyester obtainable by reacting mono-, di-, tri- or polycarboxylic acid or derivative thereof with mono-, di-, tri-, tetra- or polyol, wherein
the average functionality of the carboxyl groups f.A and the hydroxyl groups f.B in the notionally hydrolyzed polyester is governed by the following selection criteria:
f.A+f.B>4,
with f.A≧2 and f.B≧2 or
with f.A>2 and f.B≧f.A/(f.A−1) or
with f.A≧f.B/(f.B−1) and f.B>2, and
in the notionally hydrolyzed polyester the selection criteria governing the mole fraction of the carboxyl groups x.A are as follows:
f.A/[(f.A*f.B)+f.A]≦x.A≦(f.A*f.B)/[(f.A*f.B)+f.B], and
the degree of conversion, U, of the deficit functionality is governed by the following selection criteria:
U.min≦U≦U.max with
U.min=(0.5−x.A)/{0.5−f.A/[(f.A*f.B)+f.A]}*100%, if x.A≦0.5, U.min=(x.A−0.5)/{[f.A*f.B]/[(f.A*f.B)+f.B]−0.5}*100%, if x.A>0.5,
U.max=99.99%, if f.A/[(f.A*f.B)+f.A]≦x.A≦f.A/[f.A+(f.A−1)*f.B]
U.max=[2/f.max+(0.5−x.A)/{0.5−(f.A)/[f.A+(f.A−1)*f.B]}*(1-2/f.max)]*100%, if f.A/[f.A+(f.A−1)*f.B]]<x.A≦0.5
U.max=[2/f.max+(x.A−0.5)/{[f.A*(f.B−1)]/[f.B+f.A*(f.B−1)]−0.5}*(1−2/f.max)]*100%, if 0.5<x.A≦[(f.B−1)*f.A]/[f.B+(f.B−1)*f.A]
U.max=99.99%, if [(f.B−1)*f.A]/[f.B+(f.B−1)*f.A]<x.A≦[f.A*f.B]/[(f.A*f.B)+f.B].

2. A process for preparing a nongelling and noncrosslinked, highly branched or hyperbranched polyester by reacting di-, tri- or polycarboxylic acid A or derivative thereof and di-, tri-, tetra- or polyol B and also, optionally, monocarboxylic acid, optionally, monoalcohol, and, optionally, hydroxycarboxylic acid, wherein
the average functionality of the carboxyl groups f.A and the hydroxyl groups f.B in the notionally hydrolyzed polyester is governed by the following selection criteria:
f.A+f.B>4,
with f.A≧2 and f.B≧2 or
with f.A>2 and f.B≧f.A/(f.A−1) or
with f.A≧f.B/(f.B−1) and f.B>2, and
in the notionally hydrolyzed polyester the selection criteria governing the mole fraction of the carboxyl groups x.A are as follows:
f.A/[(f.A*f.B)+f.A]≦x.A≦(f.A*f.B)/[(f.A*f.B)+f.B], and
the degree of conversion, U, of the deficit functionality is governed by the following selection criteria:
U.min≦U≦U.max with
U.min=(0.5−x.A)/{0.5−f.A/[(f.A*f.B)+f.A]}*100%, if x.A≦0.5, U.min=(x.A−0.5)/{[f.A*f.B]/[(f.A*f.B)+f.B]−0.5}*100%, if x.A>0.5,
U.max=99.99%, if f.A/[(f.A*f.B)+f.A]≦x.A≦f.A/[f.A+(f.A−1)*f.B]
U.max=[2/f.max+(0.5−x.A)/{0.5−(f.A)/[f.A+(f.A−1)*f.B]}*(1−2/f.max)]*100%, if f.A/[f.A+(f.A−1)*f.B]]<x.A≦0.5
U.max=[2/f.max+(x.A−0.5)/{[f.A*(f.B−1)]/[f.B+f.A*(f.B−1)]−0.5}*(1−2/f.max)]*100%, if 0.5<x.A≦[(f.B−1)*f.A]/[f.B+(f.B−1)*f.A]
U.max=99.99%, if [(f.B−1)*f.A]/[f.B+(f.B−1)*f.A]<x.A≦[f.A*f.B]/[(f.A*f.B)+f.B].

3. The polyester or process according to claim 1 or 2, wherein the average acid functionality f.A is ≧2 and the average alcohol functionality f.B is >2.

4. The polyester or process according to claim 1 or 2, wherein the average alcohol functionality f.B is ≧2 and the average acid functionality f.A is >2.

5. The polyester or process according to claim 1 or 2, wherein the average acid functionality f.A is >2 and the average alcohol functionality f.B is ≧f.A/(f.A−1).

6. The polyester or process according to claim 1 or 2, wherein the average alcohol functionality f.B is >2 and the average acid functionality f.A is ≧f.B/(f.B−1).

7. The polyester or process according to claim 1 or 2, wherein the mole fraction of the carboxyl groups is governed by f.A/[(f.A*f.B)+f.A]≦x.A≦f.A/[f.A+(f.A−1)*f.B].

8. The polyester or process according to claim 1 or 2, wherein the mole fraction of the carboxyl groups is governed by f.A/[f.A+(f.A−1)*f.B]]<x.A≦0.5.

9. The polyester or process according to claim 1 or 2, wherein the mole fraction of the carboxyl groups is governed by 0.5<x.A≦[(f.B−1)*f.A]/[f.B+(f.B−1)*f.A].

10. The polyester or process according to claim 1 or 2, wherein the mole fraction of the carboxyl groups is governed by [(f.B−1)*f.A]/[f.B+(f.B−1)*f.A]<x.A≦[f.A*f.B]/[(f.A*f.B)+f.B].

11. The polyester or process according to claim 1 or 2, wherein the conversion of the hydroxyl groups is limited to values (0.5−x.A)/{0.5−f.A/[(f.A*f.B)+f.A]}*100%≦U≦99.99%.

12. The polyester or process according to claim 1 or 2, wherein the conversion of the hydroxyl groups is limited to values (0.5−x.A)/{0.5−f.A/[(f.A*f.B)+f.A]}*100%<U<[2/f.max+(0.5−x.A)/{0.5−(f.A)/[f.A+(f.A−1)*f.B]}*(1−2/f.max)]*100%, and f.max=f.A if f.A≧f.B, or f.max=f.B if f.A<f.B.

13. The polyester or process according to claim 1 or 2, wherein the conversion of the carboxyl groups is limited to values (x.A−0.5)/{[f.A*f.B]/[(f.A*f.B)+f.B]−0.5}*100%≦U≦[2/f.max+(x.A−0.5)/{[f.A*(f.B−1)]/[f.B+f.A*(f.B−1)]−0.5}*(1−2/f.max)]*100%, and f.max=f.A if f.A≦f.B, or f.max=f.B if f.A<f.B.

14. The polyester or process according to claim 1 or 2, wherein the conversion of the carboxyl groups is limited to values (x.A−0.5)/{[f.A*f.B]/[(f.A*f.B)+f.B]−0.5}*100%≦U≦99.99%.

15. The polyester or process according to claim 1 or 2, wherein the mole fraction of the carboxyl groups is governed by f.A/[(f.A*f.B)+f.A]≦x.A≦f.A/[f.A+(f.A−1)*f.B] and the conversion of the hydroxyl groups is limited to values (0.5−x.A)/{0.5−f.A/[(f.A*f.B)+f.A]}*100%≦U≦99.99%.

16. The polyester or process according to claim 1 or 2, wherein the mole fraction of the carboxyl groups is governed by f.A/[f.A+(f.A−1)*f.B]]<x.A≦0.5 and the conversion of the hydroxyl groups is limited to values (0.5−x.A)/{0.5−f.A/[(f.A*f.B)+f.A]}*100%≦U≦[2/f.max+(0.5−x.A)/{0.5−(f.A)/[f.A+(f.A−1)*f.B]}*(1−2/f.max)]*100%, and f.max=f.A if f.A≧f.B, or f.max=f.B if f.A<f.B.

17. The polyester or process according to claim 1 or 2, wherein the mole fraction of the carboxyl groups is governed by 0.5<x.A≦[(f.B−1)*f.A]/[f.B+(f.B−1)*f.A], and the conversion of the carboxyl groups is limited to values (x.A−0.5)/{[f.A*f.B]/[(f.A*f.B)+f.B]−0.5}*100%≦U≦[2/f.max+(x.A−0.5)/{[f.A*(f.B−1)]/[f.B+f.A*(f.B−1)]−0.5}*(1−2/f.max)]*100%, and f.max=f.A if f.A≧f.B or f.max=f.B if f.A<f.B.

18. The polyester or process according to claim 1 or 2, wherein the mole fraction of the carboxyl groups is governed by [(f.B−1)*f.A]/[f.B+(f.B−1)*f.A]<x.A≦[f.A*f.B]/[(f.A*f.B)+f.B] and the conversion of the carboxyl groups is limited to values (x.A−0.5)/{[f.A*f.B]/[(f.A*f.B)+f.B]−0.5}*100%≦U≦99.99%.

19-22. (canceled)

23. A method of formulating an adhesive, comprising:
incorporating the polyester according to claim 1 as an adhesion promoter into the components of an adhesive material.

24. A method of formulating a printing ink, comprising:
incorporating the polyester according to claim 1 into the components of a printing ink.

25. A method of modifying the rheology characteristics of a substance, comprising:
incorporating the polyester according to claim 1 into said substance.

26. A method, comprising:
formulating substances which function as a surface or interface modifier, as a functional polymer additive, as a building block for preparing a polyaddition or polycondensation polymer, in a paint, covering, adhesive, sealant, casting elastomer or foam, in a dispersion, as a surface-active amphoteric, as a blend component in a thermoplastic molding compound or in a binder for a one-component or multicomponent paint system utilizing the polyester according to claim 1 as a component.
